(19) United States
(12) Patent Application Publication
(10) Pub. No.: US 2010/0237082 A1
(43) Pub. Date: Sep. 23, 2010

(54) Gel cushion mat

(75) Inventor: Juan Fernandez, Towaco, NJ (US)

Correspondence Address: Gearhart Law LLC, 4 Ferndale Road, Chatham, NJ, 07928, US

(73) Assignee: Products of Tomorrow, Inc., Towaco, NJ (US)

(21) Appl. No.: 12/658,841

(22) Filed: Feb. 16, 2010

Related U.S. Application Data
(60) Provisional application No. 61/210,553, filed on Mar. 20, 2009.

(51) Int. Cl. A47J 41/00; B32B 3/26; B32B 3/00; B32B 5/02; B32B 1/08; A47C 20/02

(52) U.S. Cl. 220/592.17; 428/304.4; 428/158; 442/1; 428/152; 428/34.1; 5/655.5

(57) ABSTRACT

The invention is a pad having a layer of resilient gel disposed on a layer of foam. The gel layer is preferably a silicone gel or other resilient gel such as a thermoplastic elastomer (TPE), SEBS or SEPS and the foam layer is preferably EVA foam. A soft rubber could also be used. The gel layer of the pad may have geometric cutouts such as pleats, grooves, flutings, corrugations, serrated shape, or any combination. The geometric cutouts may have a round, square, trapezoidal, triangular, rectangular, rectangular with rounded corners, half round shape or any combination. The geometric cutouts may also be hollow to further reduce gel material. The shape of the gel layer may be different or independent of the shape of any serrations or geometric cutouts on the foam layer. The pad may be flat or may be formed into a sleeve, a holder for beverage containers, a support pad, or a seat cushions. Many other uses and shapes are conceivable.

### CLAIM OF PRIORITY

This application claims priority to U.S. Ser. No. 61/210,553 filed Mar. 20, 2009, the contents of which are fully incorporated herein by reference.

### FIELD OF THE INVENTION

The invention relates to anti-fatigue mats, and in particular floor mats.

### BACKGROUND OF THE INVENTION

Anti-fatigue floor mats are well known in the art. An anti-fatigue mat is a pad which supports a user while the user is doing a stationary task. The mats are commonly employed in kitchens, workshops, and manufacturing facilities where the user must stand for long periods of time in a stationary position. The cushioning of the anti-fatigue mat reduces stress and tension on the users leg muscles and back, making the user more comfortable during the task performed.

The mats are available in a variety of materials and configurations. In one particular configuration, the mat is made primarily of resilient gel material. The resilient gel material is an excellent material for anti-fatigue mats and pads, because it provides an appropriate amount of cushioning and comfort to the user. However, the drawback to using a mat constructed primarily or entirely of gel, is that resilient gel is an expensive material. Examples of the art in this area are cited below.

U.S. Pat. No. 6,851,141 teaches a resilient mat which provides cushioning and comfort to users standing thereon or otherwise contacting the mat. The mat includes a resilient gel inner layer surrounded by a support ring to which an upper cover member and a lower cover member are attached. The support ring exhibits stiffness greater than the stiffness of the upper and lower cover members so that adherence of the upper and lower cover members to the support ring is enhanced even after prolonged use. The upper and lower cover members can exhibit the same or different colors in particular embodiments. The upper and lower cover members also can exhibit anti-slip properties in selected embodiments.

US Patent Application 20080078028 teaches a method and apparatus for fabricating an anti-fatigue mat that employs a layer of resilient gel material. The method employs a frame assembly that receives a flexible sheet to form the base sheet of the mat. In one embodiment, the frame assembly includes a movable frame member having an angled aperture for controlling the geometry of the gel layer when heated gel is dispensed into the aperture. In one embodiment, the frame assembly receives another flexible sheet disposed on the gel layer to form the support sheet of the mat. In one embodiment, the frame assembly may further include a cooling channel for convective or liquid cooling of liquid gel dispensed into a gel receiving cavity formed by the aperture.

US Patent Application 20080113170 teaches a method and apparatus for fabricating an anti-fatigue mat that employs a layer of resilient gel material that exhibits a first durometer. The method employs a frame assembly that receives a flexible support sheet. The frame assembly includes an aperture that receives a layer of heated liquid gel which cools to form the layer of resilient gel material exhibiting the first durometer. In one embodiment, a barrier layer exhibiting a second durometer is situated on the gel layer that exhibits the first durometer. In one embodiment, the barrier layer prevents the flow of oils from the gel layer to a flexible base sheet disposed on the barrier layer. In another embodiment, the flexible base sheet may exhibit a second durometer. In either embodiment, the layers exhibiting the first and second durometer cooperate to influence the feel of the mat to the user.

While the art illustrates advances in the area of fatigue mat manufacture, there remains a need for mats that are comfortable, yet inexpensive to manufacture. The present invention teaches a mat that combines the comfort advantages of using resilient gel, however supplements at least a portion of the gel with another resilient material such as foam. Consequently, the advantages of the resilient gel material are utilized, while cost advantages are obtained by using a less expensive supporting layer. In the case of the present invention, the supporting layer is ethyl vinyl alcohol (EVA), however it could be other materials as well.

### SUMMARY OF THE INVENTION

The invention is a pad having a layer of resilient gel disposed on a layer of foam. The gel layer is preferably a silicone gel or other resilient gel such as styrene-ethylene/butylene-styrene (SEBS OR SEPS) or a thermoplastic elastomer (TPE) and the foam layer is preferably EVA foam. A soft rubber could also be used. Styrene-ethylene/propylene-styrene (SEPS) or other second generation styrene block copolymers may also be utilized.

The gel layer of the pad may have geometric cutouts such as pleats, grooves, flutings, corrugations, serrated shape, or any combination. The geometric cutouts may have a round, square, trapezoidal, triangular, rectangular, rectangular with rounded corners, half round shape or any combination. The geometric cutouts may also be hollow to further reduce gel material. The shape of the gel layer may be different or independent of the shape of any serrations or geometric cutouts on the foam layer.

In addition, the foam layer of the pad may have a geometric shape and may have geometric cutouts such as a serrated, pleated, grooved, fluting, corrugated shape or any combination. The geometric cutouts may have a round, square, trapezoidal, triangular, rectangular, rectangular with rounded corners, half round shape, or any combination. The geometric cutouts may also be hollow to further reduce foam material. The gel layer may be fused, bonded, or co-molded on to the foam layer.

The layers can be combined or mated in such a way as to have flat-on-flat surfaces, serrated on serrated (such as nested or interlocked), or serrated on flat surfaces. All these combinations will provide varying degrees of support and cushioning effects for the end user. It is also possible to offer different cushioning or support effects on either side thus offering a reversible function for the pad to meet the user's desired support level and comfort. The covers of the mat may also be in different colors and with different textures.

In other embodiments, the gel layer may be sandwiched between two foam layers or a foam layer may be sandwiched between two gel layers. Other embodiments can incorporate multiple foam or gel layers. In addition, the mat can have an intermediary layer made of foam, plastic, rubber, air, or air pockets. In yet a further embodiment the mat can be reinforced with wire, a wire mesh or other rigid or bendable material so the mat can be conformed or shaped in various ways so as to retain such a shape over an extended period of time. Such application would be useful for wrapping the mat or a derivative thereof around an inanimate object or even a body part.

In one embodiment, the gel layer has a thickness of at least 4 mm and the EVA layer has a thickness of at least 3 mm. The pad may be encased in a covering material such as vinyl, polyvinyl chloride (PVC) or polyurethane (PU). The outer covering may have anti-slip properties as well as antimicrobial properties. The pad may also have an internal support structure, such as a frame, made from resilient foam or flexible plastic, said frame to act as the substrate onto which the gel layer(s) are molded, co-molded, bonded, or fused. The gel mat may also have a covering or outer layer made of polyurethane or Polyvinyl chloride

The edge or lip of the mat may have a corrugated, pleated, creased, crimped or spring type flexible section which will allow the outer most section of the edge or lip to move down and come into contact with and rest on the floor or surface onto which the mat is placed on. The outer section of the edge may have some weight or other means to assist gravity in forcing this section down to make contact and rest flat on the floor. This is particularly useful when the mat is reversible so as to have the leading edge all around the mat touching the floor or surface onto which it is placed to avoid tripping on the mat edge if it is raised or curling of the edges of the mat when stepped on.

It is an object of the invention to provide an anti-fatigue mat partially filled with a gel.

It is an object of the invention to provide an anti-fatigue mat made of a gel and another resilient substance.

It is an object of the invention to provide an anti-fatigue mat that can be made less expensively than currently available gel-filled anti-fatigue mats.

Yet another object of the present invention is to provide a hot or cold wrap.

Still another object of the present invention is to provide an insulating sleeve.

It is still another object of the present invention to provide a placemat that is capable of deterring heat transfer.

It is still another object of the present invention provide a cushion for a chair, a bed, a wheelchair, a toilet seat, a sitting pad, a leaning pad, or a resting pad.

Yet another object of the present invention is to provide an insulating holder for containers.

It is an object of the invention to provide an anti-fatigue mat that contains a flexible lip that contacts the surface beneath the mat, both to maintain stability and to keep the surface beneath the mat clean.

### BRIEF DESCRIPTION OF THE DRAWINGS

FIG. 1 is a top view of the invention.

FIGS. 2a, 2b, and 2c are a side cut-away view of the invention.

FIGS. 3a, 3b and 3c are another side cut-away view of the invention.

FIG. 4a is a side cut-away view of an alternate embodiment of the invention.

FIG. 4b is a top cut-away view of an alternate embodiment of the invention.

FIG. 5 is a front view of an alternate embodiment of the invention.

### DESCRIPTION OF THE PREFERRED EMBODIMENTS

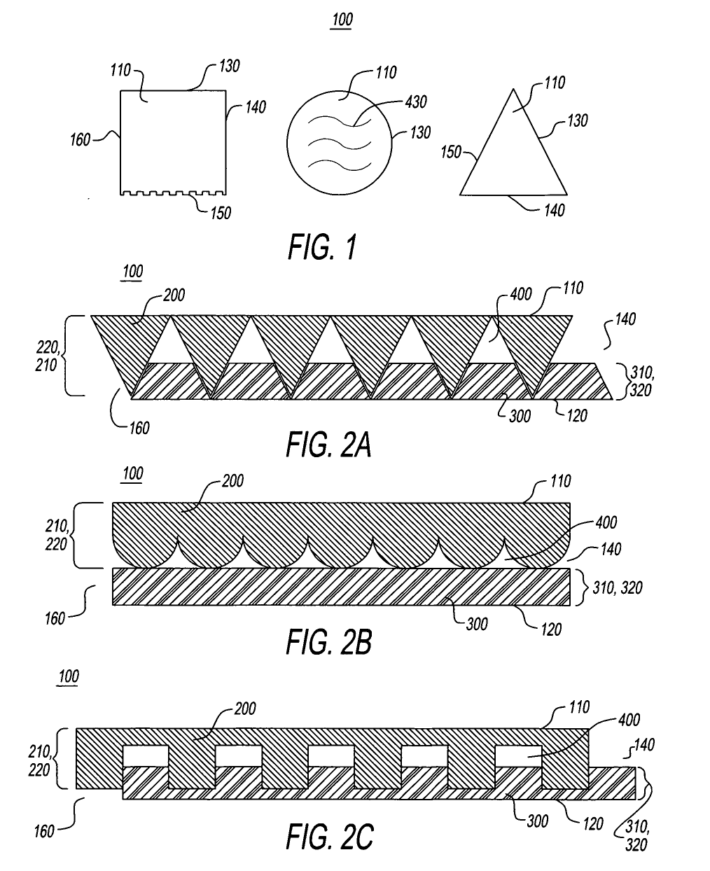

FIG. 1 is a top view of the invention. FIG. 1 shows pad 100, with pad top 110, pad first side 130, pad second side 140, pad third side 150, pad fourth side 160, and geometric cut out 430.

FIG. 1 shows three different shapes of the invention, a square, a circle, and a triangle. The invention may be any shape, including but not limited to, trapezoidal, round, square, triangular, rectangular, rectangular with rounded corners, half round, or any design, character shape, animal shape, inanimate object shape, or a logo. The invention may be any color, any number of colors, and/or any combination of colors.

The pad 100 may be covered with a permanent or removable cover. The cover may be any of the shapes described above; it may be the same shape as the pad 100 or a different shape. The cover may be made of any material, including but not limited to, rubbers, foam rubber, water, fabrics, leather, glass or glass products, sand, animal products, plant products, plastics such as vinyls, PVC or polyurethane or other petroleum products, metals, or any combination of these or other materials. The cover may be employed in any suitable manner, including but not limited to, being zipped onto the pad 100, being employed as a slipcover, attached using a hook and loop method, a snap, being permanently fused or bonded, or any other means that allows the cover to protect the pad 100. The pad top 100 and pad bottom 120 may be covered with the same materials or different materials. Further the 100 and pad bottom 120 may be covered with materials having the same or different textures or colors.

The square shape shown in FIG. 1 has a sawtooth pattern on the third side 150; this may enable two or more of the pads 100 to be joined to make a larger pad. The sawtooth pattern may be disposed on one side, all sides, or any number of sides of the pad 100, and on any shape pad.

The circular shape shown in FIG. 1 contains geometric cut outs. These cut outs may be any shape, including but not limited to, serrated, pleated, grooved, fluting, corrugated, trapezoidal, round, square, triangular, rectangular, rectangular with rounded corners, half round, or any design, character shape, animal shape, inanimate object shape, logo, indicia or combinations of any of the above. The cut outs may be any depth, ranging from 0.01% of the pad's thickness to 100% of the pad's thickness. There may be cut outs on the pad top 100, on the pad bottom 120, or on both. There may be cut outs on any of the sides of the pad 100. The cut outs on the pad 100 may be such that they can interlock with ridges on a corresponding pad so that pads may be stacked either for storage or for extra height.

FIGS. 2a, 2b and 2c are a side cut-away view of the invention. Shown is a pad 100, pad top 110, pad bottom 120, pad second side 140, pad fourth side 160, resilient gel 200, gel layer 210, gel layer thickness 220, foam 300, foam layer 310, foam layer thickness 320, intermediary layer 400.

FIGS. 2a, 2b and 2c illustrate the disposition of the two layers of the pad. The gel layer 210 is shown disposed on top of the foam layer 310. The user stands on the top of the pad, while the bottom of the pad contacts the floor or other surface. The pad 100 may be used with either the gel layer 210 on the top or with the foam layer 310 on the top. In one embodiment, the gel layer 210 and the foam layer 310 are the same shape and are joined together at a flat surface. In this embodiment, the gel layer 210 is at least 3 mm thick, and the foam layer 310 is at least 3 mm thick. In all embodiments, the gel layer 210 and the foam layer 310 may be any thickness from 0.5 mm to 30 cm, and there may be multiple layers or interspersed layers. The gel layer 210 and foam layer 310 may be the same thickness or different thicknesses, and there may be the same number of each layer or varying numbers of layers.

The gel layer 210 and the foam layer 310 may be joined in any suitable manner, including but not limited to, molded, co-molded, bonded, or fused.

Although the layers are designated as a foam layer and a gel layer, the two layers may be any substances which achieve the desired effect, that is, preventing fatigue in a user who has to stand for long periods. For instance, while the gel layer 210 preferably consists of silicone gel, TPE, SEBS or SEPS, it may consist of any other gel or gel-like substance, such as but not limited to, hydrogels, organogels, xerogels, and aerogels, or any combination of these with each other or with other compounds. TPEs are well known in the art and can be manufactured out of naphthenic rubber oil materials such as KN4006, SEPTON™ series, HYBRAR™ series, or KuramironU™ TU-S5265, since these create a TPE material that is environmentally friendly, aesthetically pleasing and exhibit an outstanding resistance to sunlight and thermal oxidation. However, the TPE useful for the present invention may also be manufactured out of other substances.

While the foam layer 310 is preferably EVA foam or other resilient material, it may be any material, such as but not limited to, natural and synthetic latex, rubbers, foam rubber, PU, PVC, polyethylene (PE), water, fabrics, leather, glass or glass products, sand, animal products, plant products, plastics or other petroleum products, vinyls, metals, or any combination of these or other materials.

In addition, the two layers may be of mixed substances. For instance, either the gel layer 210 or the foam layer 310 or both may have added filler; the filler may be any substance, including but not limited to, sand, borosilicate, or other glass products; plastics or other petroleum products; textiles; plant products; animal products; metals, or any combination of these or other substances.

In FIGS. 2a, 2b, and 2c two layers are shown with an intermediary layer 400. The two layers are shown in different shapes to indicate that any shape may be used in manufacturing the pad 100, and that the shapes of the gel layer 210 and the foam layer 310 may be different. They may also be the same shape or complimentary shapes.

The intermediary layer 400 may be any substance, including but not limited to, air, water, Styrofoam granules or other plastics or petroleum products; sand, borosilicate, or other glass products; textiles, plant products, animal products, metals, or any combination of these or other substances. There may be a resealable opening in the pad 100 to introduce or add substance to the intermediary layer 400 or to remove substance from the intermediary layer 400. For instance, a user may be able to adjust the comfort level of the pad 100 by adding or removing water through the resealable opening. In addition, the user may adjust the temperature of the pad 100 by adding hot or cold water as the intermediary layer 400.

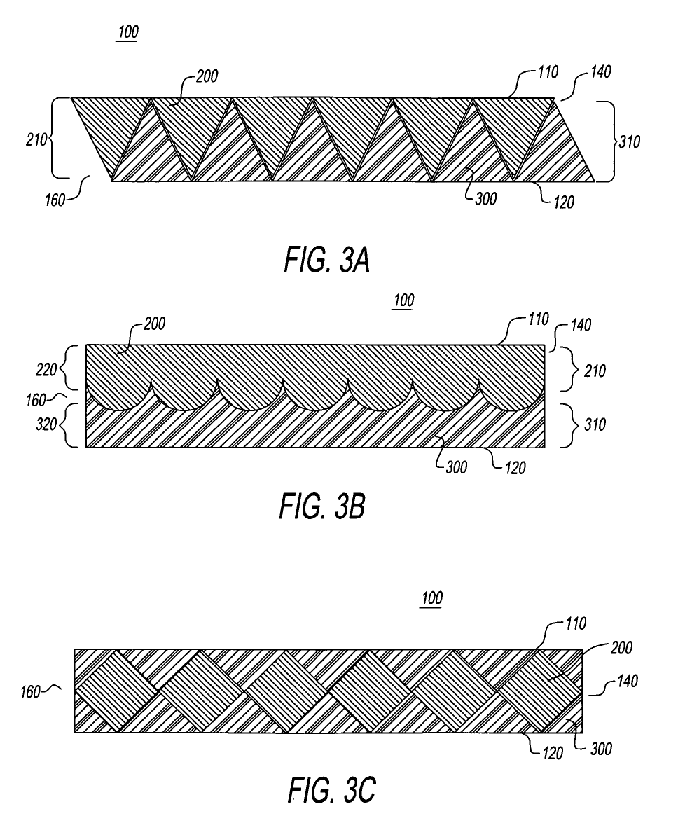

FIGS. 3a, 3b and 3c are a side cut-away view of the invention. Shown is a pad 100, pad top 110, pad bottom 120, pad second side 140, pad fourth side 160, resilient gel 200, gel layer 210, gel layer thickness 220, foam 300, foam layer 310, and foam layer thickness 320.

FIGS. 3a, 3b and 3c are illustrating the pad 100 with no intermediary layer. The gel layer 210 and foam layer 310 may be any shape, and the shapes may be manufactured to compliment each other so they mesh completely.

FIG. 3a shows how the gel layer 210 and the foam layer 310 can be manufactured to mesh with no intermediary layer. FIG. 3b shows another configuration of the invention. FIG. 3c illustrates how the resilient gel 200 and the foam 300 can be interspersed in the pad 100. In FIG. 3c, the resilient gel 200 is shown present in the same amount as the foam 300, but the foam may make up a larger proportion of the pad 100. This would be desirable to reduce cost. Alternately, the resilient gel 200 may make up the larger proportion of the pad 100 based on comfort. The proportion of resilient gel 200 to foam 300 in the pad 100 may range from 0.01% to 99.9%, with a preferred proportion of between 30% and 70%. Further, layers may be constructed of foam, sandwiched between two gel layers. The two gel layers may comprise the same or different gel types. In another embodiment, a gel layer is sandwiched between two foam layers. The two foam layers may be the same or may be different foam types.

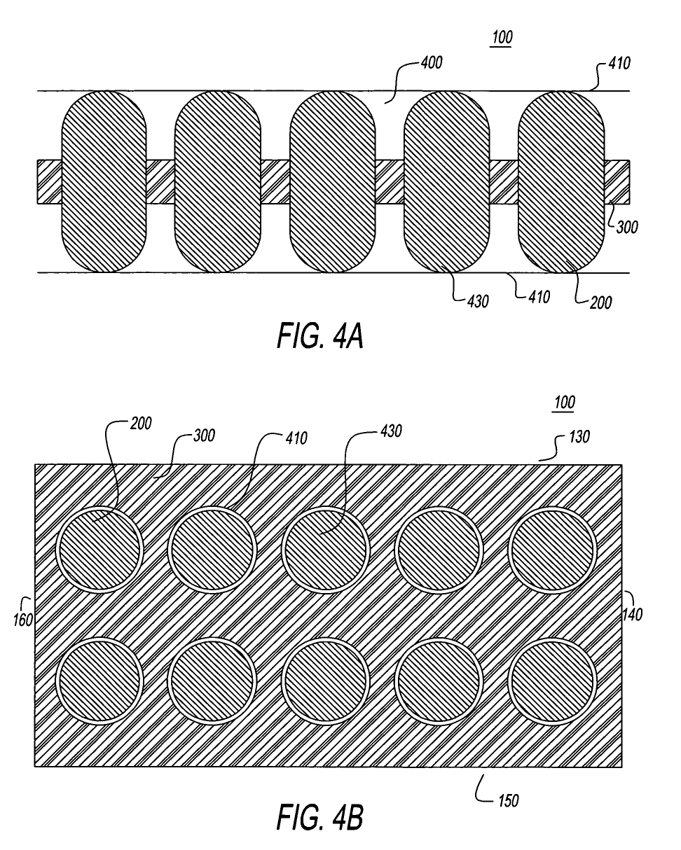

FIG. 4a is a side cut-away view of an alternate embodiment of the invention which contains an internal frame. FIG. 4 shows pad 100, resilient gel 200, foam 300, intermediary layer 400, internal frame 410, and geometric cut out 430.

FIG. 4b is a top cut-away view of another embodiment of the invention. FIG. 4b shows pad 100, pad first side 130, pad second side 140, pad third side 150, pad fourth side 160, resilient gel 200, foam 300, internal frame 410, and geometric cut out 430.

FIGS. 4a and 4b illustrate the resilient gel 200 interspersed with the foam 300, and an internal frame 410 that adds support and structure to the pad 100. FIG. 4a also shows an intermediary layer 400 interspersed with the resilient gel 200 and foam 300. FIG. 4b shows the pad 100 with no intermediary layer. As noted above, the shapes of the resilient gel 200 portion and the foam 300 portion may be any shapes, and the intermediary layer 400 may be any shape or substance described above.

The internal frame 410 is shown in different configurations in FIGS. 4a and 4b. In FIG. 4a the internal frame 410 is a continuous piece that contacts a number of resilient gel 200 portions; in FIG. 4b the internal frame 410 is bonded or fused to the resilient gel 200 so that each resilient gel 200 portion is supported by a separate internal frame 400. The internal frame 410 may be any shape and may be disposed in any one, two, three, or all of the layers of the pad 100. The internal frame 410 may be dispersed throughout the pad 100 in any pattern, and may constitute any proportion of the pad 100, from 0% to 99.9%, with a preferred proportion of 30% to 70%.

The internal frame 410 may be made of any material, preferably wire, wire mesh, or other rigid or bendable material, and also other materials, including but not limited to, fiberglass or other glass products, rubbers, fabrics, leather, animal products, plant products, plastics or other petroleum products, vinyls, metals, or any combination of these or other materials.

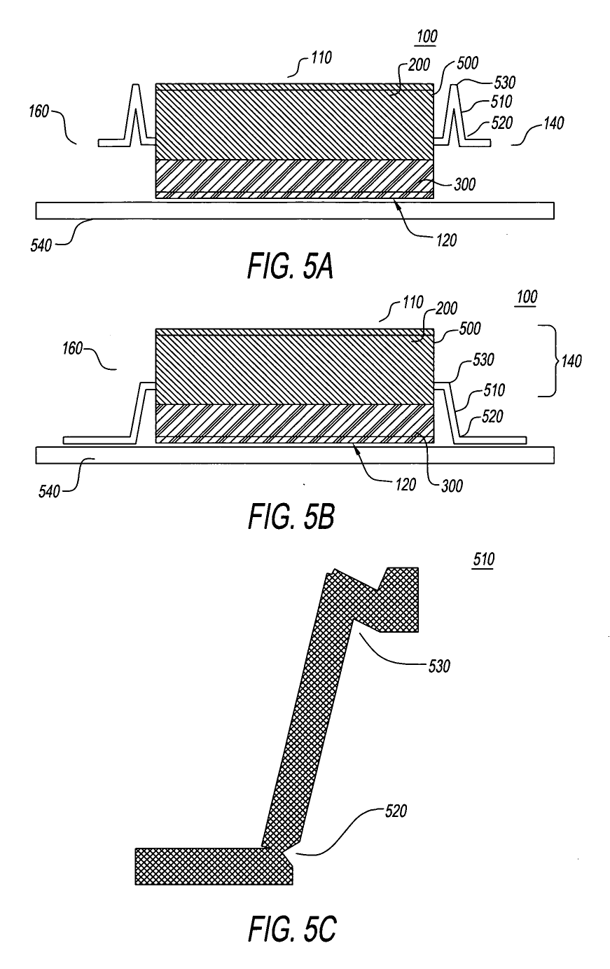

FIG. 5 is a front view of an alternate embodiment of the invention which contains a flexible lip. FIG. 5 shows pad 100, pad top 110, pad bottom 120, pad second side 140, pad fourth side 160, resilient gel 200, foam 300, pad edge 500, flexible lip 510, flexible lip bent portion 520, flexible lip angled portion 530 and surface 540.

The purpose of the flexible lip 510 is to keep dirt from getting under the edge of the pad 100 and to reduce a tripping hazard from the raised pad surface. The flexible lip 510 may be configured in such a way as to keep it in contact with the surface, such as but not limited to, being weighted in all or part of the flexible lip, being coated with a sticky but releasable substance on all or part of the flexible lip, or other means.

FIG. 5a shows the flexible lip 510 in an upright position, and FIG. 5b shows the flexible lip 510 contacting a surface 540. The flexible nature of the flexible lip 510 allows it to be used with either the top side or the bottom side of the pad 100. The flexible lip 510 may be designed with a bent portion 520, an angled portion 530, or both. In addition, there may be multiple bent portions 520 or angled portions 530. The flexible lip 510 may be disposed anywhere on the pad 100, but is preferably disposed on one or more sides of the pad 100. The flexible lip 510 may be connected to the edge in any manner, including but not limited to, with a portion that is corrugated, creased, bent or angled. It may be integral in manufacture or be retrofitted to the pad 100. If retrofitted, the flexible lip 510 may be attached by any means, including but not limited to, through a hook and loop fastener, snap, adhesive, fusing, or other any means. Further the flexible lip may be covered with material matching the remainder of the mat, or may have one material on the side facing upward and another material on the side which comes in contact with the surface 540. In addition, the portions which are corrugated, creased bent or angled may be reinforced to prevent tearing of the material.

The pad 100 or a cover may also have means to keep it in place, such as but not limited to, added weight, being coated with a sticky but releasable substance, having a non-skid pattern on the top and/or bottom surfaces, having a hook and loop portion that corresponds to a hook and loop portion on a permanent surface, or other means.

The pad 100 may be manufactured from materials having very substantial thermal stability, high viscosity and low thermal loss. Therefore, many useful and diverse applications are possible. For example, the present invention may be used as a hot or cold wrap. The hot or cold items, such as lab equipment or household utensils, may be wrapped in a pad embodied in the present invention, or inserted into a sleeve or pocket formed out of a pad 100 (not shown). There may also be a comfort handle built into, or molded into the present invention that is embodied in a sleeve or a pocket. Furthermore, a pad 100 may be formed a placemat. Such a placemat may function as an insulator of hot and cold objects, such as pots, from the supporting surfaces, such as tabletops and countertops. The support surface would thus be protected from the scorching or scolding temperatures of pots and pans, while pots and pans would be protected from the heating or cooling affects of the supporting surface.

The cushioning and elastic nature of the present invention may be utilized in many other settings. For example, the pad 100 may used as a cushion for a chair, a bed, a wheelchair, a toilet seat, a sitting pad, a leaning pad, a resting pad, or any combination or derivatives of these items. The pad 100 may also be formed as an insulating holder for a beverage container. One skilled in the art would recognize the significant utility of the present invention and its usefulness in many applications.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A pad, comprising:
a layer of resilient gel disposed on a layer of foam.

2. The pad of claim 1, wherein the gel layer has a geometric cut out selected from the group consisting of serrated, pleated, grooved, fluting, or corrugated shape.

3. The pad of claim 1, wherein the gel layer is fused to the foam layer.

4. The pad of claim 1, wherein there is an intermediary layer between the gel and foam layers.

5. The pad of claim 1, wherein the gel layer has a thickness of at least 3 mm.

6. The pad of claim 1, wherein the foam layer has a thickness of at least 3 mm.

7. The pad of claim 1, wherein the pad is coated with a covering material.

8. The pad of claim 1, wherein the pad has an internal frame.

9. The pad of claim 1, wherein the pad is reversible.

10. The pad of claim 1, wherein the gel layer is made from silicone gel or SEBS or SEPS.

11. The pad of claim 1, wherein the foam layer is EVA foam.

12. The pad of claim 1, wherein the gel layer has wire or a wire mesh disposed therein.

13. The pad of claim 1, wherein the pad has an edge, and a flexible lip is disposed on the edge.

14. The pad of claim 1, wherein the flexible lip is weighted.

15. The pad of claim 1, wherein the flexible lip is connected to the edge with a portion that is corrugated, creased, bent or angled.

16. The pad of claim 1, wherein the gel layer is made from a TPE material.

17. The pad of claim 1, further comprising a removable cover.

18. The pad of claim 1, wherein said pad is a hot or cold wrap.

19. The pad of claim 1, wherein said pad is a placemat.

20. The pad of claim 1, wherein said pad may support a hot or cold object on a supporting surface, said pad insulating said supporting surface from said hot or cold object.

21. The pad of claim 1, wherein said pad is a cushion for a chair, a bed, a wheelchair, a toilet seat, a sitting pad, a leaning pad, or a resting pad.

22. The pad of claim 1, wherein said pad forms a sleeve.

23. The pad of claim 1, wherein said pad forms an insulating holder for a beverage container.
